(19) United States
(12) Patent Application Publication
(10) Pub. No.: US 2002/0112010 A1
(43) Pub. Date: Aug. 15, 2002

(54) Selective dissemination of electronic mail attachments

(75) Inventors: Danny Soroker, Tel Aviv (IL); Netta Shani, Haifa (IL)

Correspondence Address: S. Peter Ludwig, Darby & Darby P.C., 805 Third Avenue, New York, NY, 10022, US

(73) Assignee: INTERNATIONAL BUSINESS MACHINES CORPORATION

(21) Appl. No.: 09/783,412

(22) Filed: Feb. 14, 2001

(51) Int. Cl. G06F 15/16

(52) U.S. Cl. 709/206

(57) ABSTRACT

A method is provided for processing an electronic mail (e-mail) message having an attachment. The method includes receiving as input from the sender the e-mail message and the attachment, for transmission across a network. In addition, designations of respective first and second sets of one or more recipients are received from the sender. The e-mail message and the attachment are sent to the first set of one or more recipients, and the e-mail message without the attachment is sent to the second set of one or more recipients. Alternatively or additionally, the method includes receiving as input from a sender the e-mail message and the attachment for transmission to a recipient. Additionally, an instruction is received from the sender, indicative of whether to save the attachment. The e-mail message and the attachment are sent to the recipient, and, if the instruction indicates that the attachment is not to be saved, then the e-mail message is saved without the attachment.

### FIELD OF THE INVENTION

The present invention relates generally to electronic mail, and specifically to methods and apparatus for processing electronic mail.

### BACKGROUND OF THE INVENTION

The exchange of messages between two or more users employing electronic mail (e-mail) is widely known. A piece of e-mail typically includes a short message or piece of text. In addition, larger files called attachments are often attached to and sent with the e-mail. The attachments may include, for example, graphics files, audio or video files, word processing files, or other data files.

U.S. Pat. No. 5,948,058 to Kudoh et al., which is incorporated herein by reference, describes a method for cataloging and displaying e-mail.

U.S. Pat. No. 5,544,360 to Lewak et al., which is incorporated herein by reference, describes a method for accessing computer files and data, using linked categories assigned to each data file record on entry of the data file.

U.S. Pat. Nos. 5,771,355 and 5,781,901 to Kuzma, and U.S. Pat. No. 5,613,108 to Morikawa, which are incorporated herein by reference, describe various methods for processing e-mail.

U.S. Pat. No. 5,903,723 to Beck et al., which is incorporated herein by reference, describes a method for transmitting electronic mail attachments with attachment references. An attachment reference is generated, including a network address where the attachment is stored. The attachment reference is transmitted from the sender to a recipient, and the recipient is enabled to access the attachment at the network address.

The prior art does not provide a full solution to the congestion of pathways of a communication network when e-mails with heavy attachments are sent to a multiplicity of recipients. Lotus Notes (Lotus Notes 4.5 Standard Mail Template Version 7, from Lotus, Cambridge, Mass.) gives a user the option of either sending or not sending attachments in replied and forwarded mail. U.S. Pat. No. 5,903,723 partially addresses the problem of network congestion by sending the e-mail without the attachment, but with an attachment reference. Nevertheless, if many or all of the multiplicity of recipients want to receive the attachment, a large amount of network bandwidth will still be consumed.

Some e-mail programs (e.g., Lotus Notes) provide graphical user interface (GUI) features that add “mood stamps” to an e-mail, in order to change the way in which the e-mail appears at the receiving end.

Some other programs (e.g., “Scan Mail for Open Mail,” Trend Micro Inc., Cupertino, Calif.) filter received e-mail and prevent virus-infected e-mail attachments from being transferred to their designated recipients.

### SUMMARY OF THE INVENTION

It is an object of some aspects of the present invention to provide improved apparatus and methods for electronic mail processing.

In preferred embodiments of the present invention, an e-mail processing system enables a user to prepare an e-mail message with an attachment. The user designates to the system which of a number of recipients should receive the e-mail message together with the attachment, and which of the recipients should receive the message without the attachment. The system, in turn, prepares and sends the email over a network in accordance with the user's designation, without requiring the user to manually prepare separate e-mails for the different groups of recipients.

The methods of processing e-mail described herein typically significantly reduce the loading of the network, by reducing the total number of copies of attachments which are sent to the recipients. By contrast, prior art e-mail systems typically send an e-mail and its attachment to all of the listed recipients, without providing an option for specifying those recipients who should not receive the attachment. Thus, using any of the most popular e-mail programs available today, a user who wants to send a 10 kB e-mail with a 5 MB attachment to 40 recipients will ultimately cause the transfer of 400 kB of e-mail and 200 MB of attachments. These prior art programs do not enable the user to specify that, for example, three of the recipients should receive the attachment with the e-mail message, and the remainder should receive only the message.

It is noted that in addition to saving resources of the network, these embodiments of the present invention additionally reduce recipients' downloading time and conserve hard disk space on computers of recipients who would otherwise have received the attachment. (Very few e-mail recipients, it is believed, make a practice of going through their received e-mail and deleting unwanted attachments to e-mail messages.)

Advantageously, these embodiments of the present invention typically enhance the user's expressive power in composing e-mail, by enabling her to more efficiently customize the message conveyed to each recipient. Thus, for example, an engineer may utilize these embodiments of the present invention to send a project update to managers and technicians in her organization, but designate that several large raw data files only be attached to the e-mail sent to the technicians. In another example, an attached file may include confidential information appropriate for only certain designated recipients, while the e-mail message to which the file is attached may be of a more general nature.

Alternatively or additionally, preferred embodiments of the present invention enable the user to conserve system resources by designating, at the time of writing or sending an e-mail message, whether a file attached thereto should be saved on the user's computer (as is the default setting of most e-mail programs), or whether only the e-mail message should be saved. Preferably, if the user chooses not to save the attached file with the e-mail message, then the name of the attached file and/or other identifying information is saved with the message. It will be appreciated that these embodiments can operate in conjunction with or separately from the embodiments of the present invention in which the user designates which recipients should receive a given attachment.

There is therefore provided, in accordance with a preferred embodiment of the present invention, a method for processing an electronic mail (e-mail) message having an attachment, including:

receiving as input from a sender the e-mail message and the attachment, for transmission across a network;

receiving as input from the sender a designation of a first set of one or more recipients and a designation of a second set of one or more recipients;

sending the e-mail message and the attachment to the first set of one or more recipients; and

sending the e-mail message without the attachment to the second set of one or more recipients.

Preferably, receiving the designation of the first set includes extracting respective addresses of the one or more recipients in the first set from a field of the e-mail message indicative of primary recipients, and wherein receiving the designation of the second set includes extracting respective addresses of the one or more recipients in the second set from a field of the e-mail message indicative of secondary recipients.

In some preferred embodiments, receiving the designations includes:

displaying a list of all recipients of the e-mail message; and

receiving from the sender respective designations with respect to at least some of the displayed recipients, which differentiate between those recipients who are to be placed in the first set and those recipients who are to be placed in the second set.

Alternatively or additionally, the method includes:

displaying a first visual representation, indicating that the one or more recipients in the first set were sent the e-mail message and the attachment; and

displaying a second visual representation, different from the first representation, indicating that the one or more recipients in the second set were sent the e-mail message without the attachment.

Preferably, the method further includes sending to the second set of one or more recipients information identifying the attachment. Alternatively or additionally, the method includes sending to the second set of one or more recipients respective identifiers of the one or more recipients in the first set.

For some applications, receiving the e-mail message and the attachment includes receiving, as input from the sender, the e-mail message and a plurality of attachments,

wherein receiving the designation of the first set includes receiving respective designations, for each recipient in the first set, of which one or more of the plurality of attachments are to be sent to that recipient, and

wherein sending the e-mail message and the attachment to the first set of one or more recipients includes:

sending the e-mail message to the first set of one or more recipients; and

sending, to each recipient in the first set, the one or more of the plurality of attachments designated to be sent to that recipient.

There is further provided, in accordance with a preferred embodiment of the present invention, apparatus for processing an electronic mail (e-mail) message having an attachment, including:

a data port; and

a processor, arranged to receive a designation of a first set of one or more recipients and a designation of a second set of one or more recipients, to actuate the data port to send the e-mail message and the attachment to the first set of one or more recipients, and to actuate the data port to send the e-mail message without the attachment to the second set of one or more recipients.

Preferably, the processor is arranged to extract respective addresses of the one or more recipients in the first set from a field of the e-mail message indicative of primary recipients, and to extract respective addresses of the one or more recipients in the second set from a field of the e-mail message indicative of secondary recipients.

In a preferred embodiment, the apparatus includes a display. The processor is preferably arranged to actuate the display to display a list of all recipients of the e-mail message, and to receive from a sender of the e-mail message respective designations with respect to at least some of the displayed recipients, which differentiate between those recipients who are to be placed in the first set and those recipients who are to be placed in the second set.

Alternatively or additionally, the processor is arranged to actuate the display to display a first visual representation, indicating that the one or more recipients in the first set were sent the e-mail message and the attachment. The processor is preferably further arranged to actuate the display to display a second visual representation, different from the first representation, indicating that the one or more recipients in the second set were sent the e-mail message without the attachment.

For some applications, the processor is arranged to actuate the data port to send to the second set of one or more recipients information identifying the attachment. Alternatively or additionally, the processor is arranged to actuate the data port to send to the second set of one or more recipients respective identifiers of the one or more recipients in the first set.

There is additionally provided, in accordance with a preferred embodiment of the present invention, a computer program product for processing an electronic mail (e-mail) message having an attachment, the product including a computer-readable medium having program instructions embodied therein, which instructions, when read by a computer, cause the computer to:

receive as input from a sender the e-mail message and the attachment, for transmission across a network;

receive as input from the sender a designation of a first set of one or more recipients and a designation of a second set of one or more recipients;

send the e-mail message and the attachment to the first set of one or more recipients; and

send the e-mail message without the attachment to the second set of one or more recipients.

There is yet additionally provided, in accordance with a preferred embodiment of the present invention, a method for processing an electronic mail (e-mail) message having an attachment, including:

receiving as input from a sender the e-mail message and the attachment for transmission to a recipient;

receiving as input from the sender an instruction indicative of whether to save the attachment;

sending the e-mail message and the attachment to the recipient; and

responsive to the instruction indicating not to save the attachment, saving the e-mail message without the attachment.

There is still additionally provided, in accordance with a preferred embodiment of the present invention, a computer program product for processing an electronic mail (e-mail) message having an attachment, the product including a computer-readable medium having program instructions embodied therein, which instructions, when read by a computer, cause the computer to:

receive as input from a sender the e-mail message and the attachment for transmission to a recipient;

receive as input from the sender an instruction indicative of whether to save the attachment;

send the e-mail message and the attachment to the recipient; and

responsive to the instruction indicating not to save the attachment, save the e-mail message without the attachment.

There is also provided, in accordance with a preferred embodiment of the present invention, apparatus for processing an electronic mail (e-mail) message having an attachment, including:

a data port;

a memory; and

a processor, arranged to receive from a sender an instruction indicative of whether to save the attachment, arranged to actuate the data port to send the e-mail message and the attachment to a recipient, and arranged to save the e-mail message in the memory without the attachment responsive to the instruction indicating not to save the attachment.

The present invention will be more fully understood from the following detailed description of the preferred embodiments thereof, taken together with the drawings, in which:

### BRIEF DESCRIPTION OF THE DRAWINGS

FIG. 1 is a simplified pictorial illustration showing a system for processing e-mail, in accordance with a preferred embodiment of the present invention;

FIG. 2 is a diagram of a typical prior art method for processing e-mail; and

FIG. 3 is a diagram of a method for processing e-mail, in accordance with a preferred embodiment of the present invention.

### DETAILED DESCRIPTION OF PREFERRED EMBODIMENTS

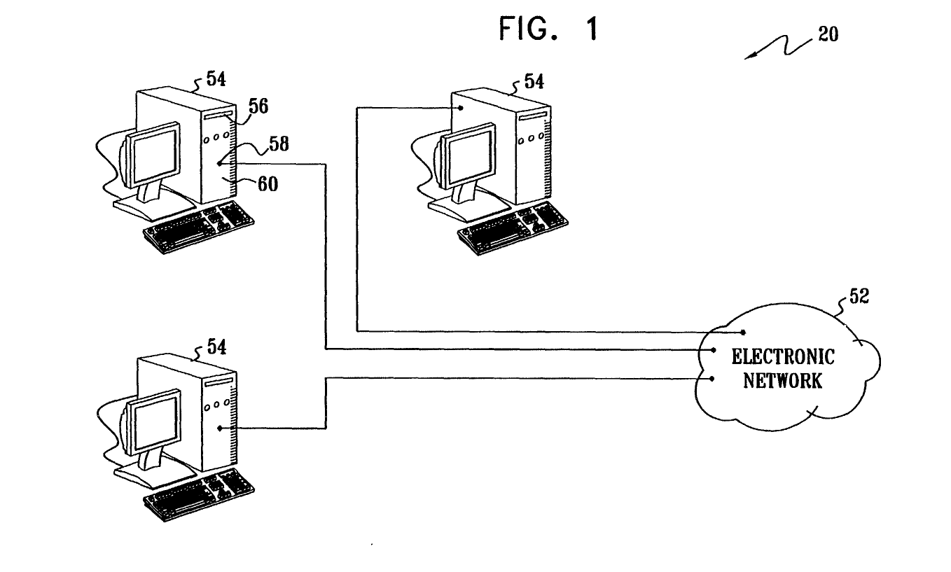

FIG. 1 is a simplified pictorial illustration showing a system 20 for processing electronic mail (e-mail), in accordance with a preferred embodiment of the present invention. Preferably, software running on a computer 54 enables a user to prepare an e-mail message for delivery to a number of recipients, and to designate which of the recipients should receive the e-mail message with an attachment, and which of the recipients should receive the message alone, without the attachment. Thus, system 20 typically reduces the loading on an electronic network 52 carrying the electronic mail by reducing the total number of copies of an attachment sent to the recipients. In addition, system 20 enables the user to focus the information being sent to each recipient, and to thereby enhance the expressive power of her electronic communications.

Computer 54 is preferably configured in accordance with standards known in the art, comprising a processor 60 which processes the user's e-mail, a memory 56, and a data port 58, through which e-mail is sent through network 52 to one or more other computers 54. Typically, but not necessarily, computer 54 comprises an ordinary personal computer, running any popular e-mail processing software which has been modified in accordance with the disclosure of the present patent application. Similarly, electronic network 52 typically comprises the Internet, but may, alternatively or additionally, include other electronic networks known in the art.

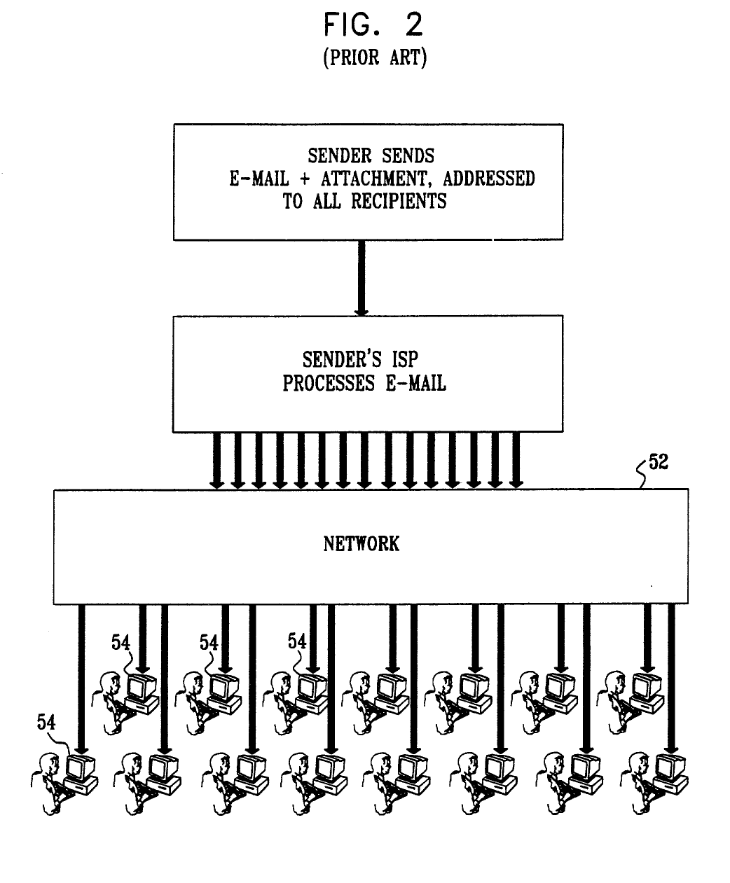

FIG. 2 is a diagram of a typical prior art method for sending an e-mail message with an attachment to a plurality of recipients 54. It is noted that even though the sender may only wish to send the attachment to a few of the 15 recipients in this example, there exists no direct method in the prior art for designating in a single piece of electronic mail those recipients who should, and those recipients who should not receive the attachment. Therefore, as shown in FIG. 2, a single copy of the e-mail message with the attachment is typically sent to the sender's Internet service provider (ISP), and the ISP transmits 15 copies of the e-mail and attachment through electronic network 52 to each of the recipients. The excess loading on the network by this prior art technique is substantial when, as is common, a large attached file is sent to a large number of users, many of whom only have to see the original e-mail message, and have no reason to receive a large file attached thereto.

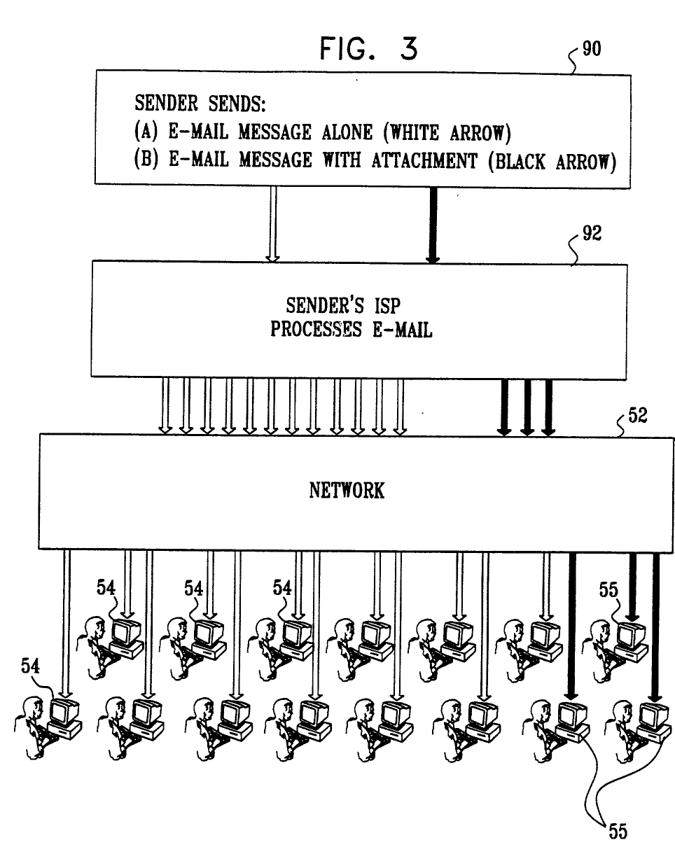

FIG. 3 is a diagram of a method for processing e-mail, in accordance with a preferred embodiment of the present invention. This embodiment typically significantly reduces the network congestion induced by prior art methods such as those described hereinabove with reference to FIG. 2.

Preferably, in a designation step 90, the user designates which recipients 54 should receive the e-mail message only, and which recipients 55 should receive the e-mail message with the attachment. For example, the user may set a default setting of the e-mail software running on her computer such that all primary recipients of an e-mail (e.g., those who are directly addressed in the “To:” field) receive the e-mail with the attachment, while secondary recipients of the e-mail (e.g., those who are addressed in the “cc:” field) receive the e-mail message without any attachment. Alternatively, a software setting may be provided in which a window with a checklist opens automatically when the user chooses “Send,” and the user is enabled to designate via the checklist which recipients of the e-mail message should also receive the attachment. When multiple attachments are associated with a single e-mail message, the user is preferably enabled to designate, if desired, which recipients should receive each of the attachments.

In all of these cases, the user is preferably enabled to subsequently review e-mail which she has sent, and see graphic icons or other symbols on a display of computer 54, which are indicative of those recipients who received the e-mail message alone and of those recipients who received the message with one or more attachments.

Further preferably, the user is enabled to designate that those recipients who receive only the e-mail message can also receive a certain amount of information about the attachments, such as the names of the attachments and/or the names of the recipients of the attachments.

It will be appreciated that by enabling a reduction in the number of attachments sent across the Internet by the user's ISP in a process/send step 92, these embodiments of the present invention offer increases in transmission speed of all of the user's messages, and, additionally, improve the efficiency of the entire Internet. In particular, since attached files are commonly 100-1,000 times larger than their associated e-mail messages, implementation of these embodiments of the present invention can reduce a major component of all electronic mail traffic on the Internet. Advantageously, the increases in speed and transmission efficiency are preferably accompanied by savings in hardware expenses, as less memory and disk space needs to be dedicated to processing and transmitting e-mail.

Typical prior art e-mail programs running on users' home computers automatically save attachments together with the e-mail messages with which they were sent. At the expense of often substantial amounts of disk space, this feature serves the sometimes-useful function of allowing a user to review e-mail she has sent and, if desired, open and interact with any attached file. Some mail servers which offer free e-mail services, such as Hotmail.com, do not offer users the ability to save attachments with sent messages, relying instead on careful users to keep track themselves of their attached files. In a preferred embodiment of the present invention, the user is enabled to designate, at the time of writing or sending an e-mail message, whether a file attached thereto should be saved on the user's computer with the e-mail message, or whether only the e-mail message should be saved. Preferably, if the user chooses not to save the attached file with the e-mail message, then the name of the attached file and/or other identifying information is saved with the message. In this manner, the user is enabled to save only those attachments which she believes might be useful at a later date, and to avoid saving attachments which she believes will not be useful. It will be appreciated that these embodiments can operate in conjunction with or separately from the embodiments of the present invention described hereinabove, in which the user designates which recipients should receive a given attachment.

It will be understood by one skilled in the art that aspects of the present invention described hereinabove can be embodied in a computer running software, and that the software can be supplied and stored in tangible media, e.g., hard disks, floppy disks or compact disks, or in intangible media, e.g., in an electronic memory, or on a network such as the Internet.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A method for processing an electronic mail (e-mail) message having an attachment, comprising:
receiving as input from a sender the e-mail message and the attachment, for transmission across a network;
receiving as input from the sender a designation of a first set of one or more recipients and a designation of a second set of one or more recipients;
sending the e-mail message and the attachment to the first set of one or more recipients; and
sending the e-mail message without the attachment to the second set of one or more recipients.

2. A method according to claim 1, wherein receiving the designation of the first set comprises extracting respective addresses of the one or more recipients in the first set from a field of the e-mail message indicative of primary recipients, and wherein receiving the designation of the second set comprises extracting respective addresses of the one or more recipients in the second set from a field of the e-mail message indicative of secondary recipients.

3. A method according to claim 1, wherein receiving the designations comprises:
displaying a list of all recipients of the e-mail message; and
receiving from the sender respective designations with respect to at least some of the displayed recipients, which differentiate between those recipients who are to be placed in the first set and those recipients who are to be placed in the second set.

4. A method according to claim 1, and comprising:
displaying a first visual representation, indicating that the one or more recipients in the first set were sent the e-mail message and the attachment; and
displaying a second visual representation, different from the first representation, indicating that the one or more recipients in the second set were sent the e-mail message without the attachment.

5. A method according to claim 1, and comprising sending to the second set of one or more recipients information identifying the attachment.

6. A method according to claim 1, and comprising sending to the second set of one or more recipients respective identifiers of the one or more recipients in the first set.

7. A method according to claim 1, wherein receiving the e-mail message and the attachment comprises receiving, as input from the sender, the e-mail message and a plurality of attachments,
wherein receiving the designation of the first set comprises receiving respective designations, for each recipient in the first set, of which one or more of the plurality of attachments are to be sent to that recipient, and
wherein sending the e-mail message and the attachment to the first set of one or more recipients comprises:
sending the e-mail message to the first set of one or more recipients; and
sending, to each recipient in the first set, the one or more of the plurality of attachments designated to be sent to that recipient.

8. Apparatus for processing an electronic mail (e-mail) message having an attachment, comprising:
a data port; and
a processor, arranged to receive a designation of a first set of one or more recipients and a designation of a second set of one or more recipients, to actuate the data port to send the e-mail message and the attachment to the first set of one or more recipients, and to actuate the data port to send the e-mail message without the attachment to the second set of one or more recipients.

9. Apparatus according to claim 8, wherein the processor is arranged to extract respective addresses of the one or more recipients in the first set from a field of the e-mail message indicative of primary recipients, and wherein the processor is arranged to extract respective addresses of the one or more recipients in the second set from a field of the e-mail message indicative of secondary recipients.

10. Apparatus according to claim 8, and comprising a display, wherein the processor is arranged to actuate the display to display a list of all recipients of the e-mail message, and wherein the processor is arranged to receive from a sender of the e-mail message respective designations with respect to at least some of the displayed recipients, which differentiate between those recipients who are to be placed in the first set and those recipients who are to be placed in the second set.

11. Apparatus according to claim 8, and comprising a display, wherein the processor is arranged to actuate the display to display a first visual representation, indicating that the one or more recipients in the first set were sent the e-mail message and the attachment, and wherein the processor is arranged to actuate the display to display a second visual representation, different from the first representation, indicating that the one or more recipients in the second set were sent the e-mail message without the attachment.

12. Apparatus according to claim 8, wherein the processor is arranged to actuate the data port to send to the second set of one or more recipients information identifying the attachment.

13. Apparatus according to claim 8, wherein the processor is arranged to actuate the data port to send to the second set of one or more recipients respective identifiers of the one or more recipients in the first set.

14. A computer program product for processing an electronic mail (e-mail) message having an attachment, the product comprising a computer-readable medium having program instructions embodied therein, which instructions, when read by a computer, cause the computer to:
receive as input from a sender the e-mail message and the attachment, for transmission across a network;
receive as input from the sender a designation of a first set of one or more recipients and a designation of a second set of one or more recipients;
send the e-mail message and the attachment to the first set of one or more recipients; and
send the e-mail message without the attachment to the second set of one or more recipients.

15. A computer program product according to claim 14, wherein the instructions, when read by the computer, cause the computer to extract respective addresses of the one or more recipients in the first set from a field of the e-mail message indicative of primary recipients, and to extract respective addresses of the one or more recipients in the second set from a field of the e-mail message indicative of secondary recipients.

16. A computer program product according to claim 14, wherein the instructions, when read by the computer, cause the computer to display a list of all recipients of the e-mail message and to receive from the sender respective designations with respect to at least some of the displayed recipients, which differentiate between these recipients who are to be placed in the first set and those recipients who are to be placed in the second set.

17. A computer program product according to claim 14, wherein the instructions, when read by the computer, cause the computer to (a) display a first visual representation, indicating that the one or more recipients in the first set were sent the e-mail message and the attachment, and (b) display a second visual representation, different from the first representation, indicating that the one or more recipients in the second set were sent the e-mail message without the attachment.

18. A computer program product according to claim 14, wherein the instructions, when read by the computer, cause the computer to send to the second set of one or more recipients information identifying the attachment.

19. A computer program product according to claim 14, wherein the instructions, when read by the computer, cause the computer to send to the second set of one or more recipients respective identifiers of the ore or more recipients in the first set.

20. A computer program product according to claim 14, wherein the instructions, when read by the computer, cause the computer to:
receive, as input from the sender, the e-mail message and a plurality of attachments;
receive respective designations, for each recipient in the first set, of which one or more of the plurality of attachments are to be sent to that recipient;
send the e-mail message to the first set of one or more recipients; and
send, to each recipient in the first set, the one or more of the plurality of attachments designated to be sent to that recipient.

21. A method for processing an electronic mail (e-mail) message having an attachment, comprising:
receiving as input from a sender the e-mail message and the attachment for transmission to a recipient;
receiving as input from the sender an instruction indicative of whether to save the attachment;
sending the e-mail message and the attachment to the recipient; and
responsive to the instruction indicating not to save the attachment, saving the e-mail message without the attachment.

22. Apparatus for processing an electronic mail (e-mail) message having an attachment, comprising:
a data port;
a memory; and
a processor, arranged to receive from a sender an instruction indicative of whether to save the attachment, arranged to actuate the data port to send the e-mail message and the attachment to a recipient, and arranged to save the e-mail message in the memory without the attachment responsive to the instruction indicating not to save the attachment.

23. A computer program product for processing an electronic mail (e-mail) message having an attachment, the product comprising a computer-readable medium having program instructions embodied therein, which instructions, when read by a computer, cause the computer to:
receive as input from a sender the e-mail message and the attachment for transmission to a recipient;
receive as input from the sender an instruction indicative of whether to save the attachment;
send the e-mail message and the attachment to the recipient; and
responsive to the instruction indicating not to save the attachment, save the e-mail message without the attachment.
